(19) United States
(12) Patent Application Publication
(10) Pub. No.: US 2006/0145922 A1
(43) Pub. Date: Jul. 6, 2006

(54) Tracking system utilizing antenna multiplexing

(76) Inventor: Edward L. Hill, Kittery, ME (US)

Correspondence Address: John G. Posa;Gifford, Krass, Groh, Sprinkle,, Anderson & Citkowski, P.C., PO Box 7021, Troy, MI, 48007-7021, US

(21) Appl. No.: 11/234,892

(22) Filed: Sep. 26, 2005

Related U.S. Application Data
(60) Provisional application No. 60/612,944, filed on Sep. 24, 2004.

(51) Int. Cl. G01S 1/24; G01S 3/02

(52) U.S. Cl. 342/387; 342/465

(57) ABSTRACT

A wireless tracking system that uses antenna multiplexing. According to the invention, a system for tracking an object includes at least one transmitter, a plurality of receiver stations, and at least one processor. The transmitter is carried on or embedded within the object, and transmits an electromagnetic signal using multiple, physically separated antennas on or within the object. The receiver stations are operative to receive the electromagnetic signal from the antennas, and the processor is operative to determine the position of the object in multiple dimensions based upon the time difference of arrival of the signal transmitted by each antenna. In the preferred embodiment, the phase center of the antennas is used as a point of reference to determine the position of the device without the need for multiple transmitters. The processor is preferably operative to determine the position of the object in three dimensions using up to six degrees of freedom.

### REFERENCE TO RELATED APPLICATION

This application claims priority from U.S. Provisional Patent Application Ser. No. 60/612,944, filed Sep. 24, 2004, the entire content of which is incorporated herein by reference.

### FIELD OF THE INVENTION

This invention relates generally to wireless tracking systems and, in particular, to a wireless tracking system that uses antenna multiplexing.

### BACKGROUND OF THE INVENTION

In many applications it is desirable to track, in a non-contact manner, the position of an object as it moves through 3-dimensional space. One method of accomplishing this is to embed an RF transmitter in the object to be tracked. Multiple RF receivers, positioned at known locations, capture the transmitted signal from the object to be tracked. Because the RF energy propagates at a known velocity, the differences in arrival time of the signal at any one pair of the receivers can be used to determine the possible positions of the tracked object in two dimensions.

If the above is carried out using several pairs of receivers, the object's position can be determined in three dimensions. A minimal setup for 3D object tracking utilizes four receivers, one that serves as a common reference for each of the other three receivers. By measuring the time difference of arrival of the signal at each of these three pairs, the resulting system of 3 equations and 3 unknowns (x, y, z coordinates) can be solved and the object's position determined.

Several deficiencies may occur with this type of system. For one, multiple transmitters are often required to increase reliability or accuracy, which can increase system cost. Accordingly, it is desirable to develop apparatus methods to enhance system accuracy in a more economical manner.

### SUMMARY OF THE INVENTION

This invention is broadly directed to a wireless tracking system that uses antenna multiplexing. According to the invention, a system for tracking an object includes at least one transmitter, a plurality of receiver stations, and at least one processor. The transmitter is carried on or embedded within the object, and transmits an electromagnetic signal using multiple, physically separated antennas on or within the object. The receiver stations are operative to receive the electromagnetic signal from the antennas, and the processor is operative to determine the position of the object in multiple dimensions based upon the time difference of arrival of the signal transmitted by each antenna.

In the preferred embodiment, the phase center of the antennas is used as a point of reference to determine the position of the device without the need for multiple transmitters. The processor is preferably operative to determine the position of the object in three dimensions using up to six degrees of freedom.

### BRIEF DESCRIPTION OF DRAWINGS

FIG. 1 is a block diagram showing the use of four (4) antennas on a single RF transmit circuit;

FIG. 2 is a block diagram showing the known physical spacing of the RF transmit circuit's antennas;

FIG. 3 is a block diagram showing the sequence of RF transmission (1 through 4) at each antenna separated over time;

FIG. 4 is a block diagram showing the use of a switch at the RF transmit circuit to perform the multiplexing transmission function at each antenna; and

FIG. 5 is a block diagram showing the use of codes (1a through 1d) to provide signal separation at each receiver in the position tracking system. The coded signals, unlike the sequential multiplexed transmissions shown in FIG. 3, can be activated at the same moment in time.

### DETAILED DESCRIPTION OF THE INVENTION

According to the invention, radio frequency (RF) transmission device(s) utilize more than one antenna on a single RF transmit circuit to produce multiple RF signal emission points. These multiple emissions create multiple points of signal emission for improved reception and multiple position point information within a position tracking system while utilizing a single radio frequency circuit saving cost and hardware space requirements.

A radio frequency (RF) signal emission device (the “device”) used as a tracked target in a position tracking system (the “system”). The device's position is determined by analyzing the time difference of arrival of the device's RF signals received at multiple receivers that are part of the system. The RF signals' time differences of arrival at each receiver are used to then determine the physical position of the device within the System's receiver network.

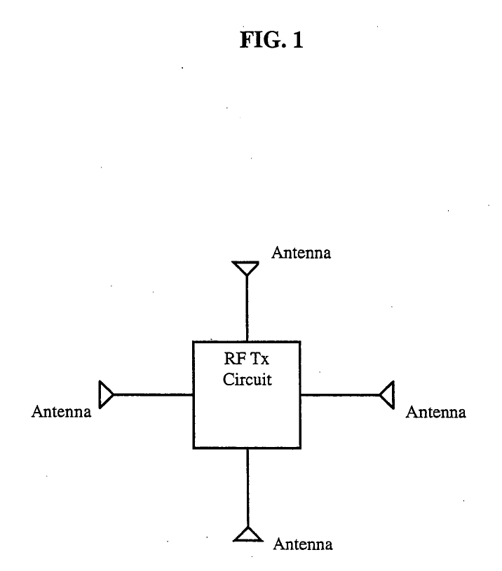

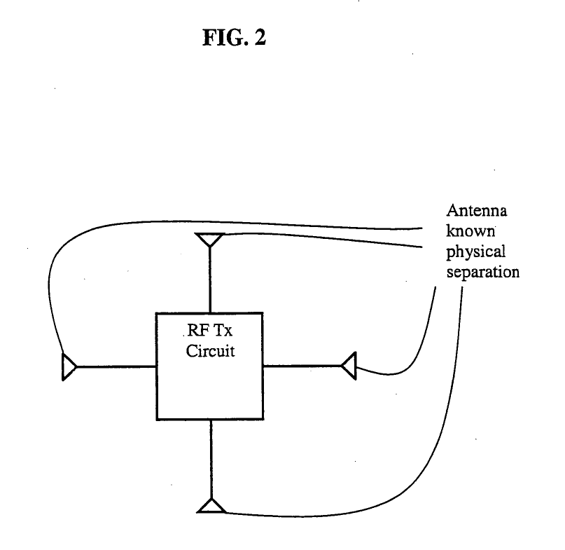

A point of novelty is the device's use of a single radio frequency transmission circuit with multiple antennas (FIG. 1). In each device, by using multiple antennas physically separated enough from themselves to provide the system with discernable position points on the device (FIG. 2), the system can determine the geometric six degrees of freedom three dimensional position of the device within the system's receiver network through the time difference of arrival of each antennas' transmitted RF signals received at each receiver. By using multiple antennas on a single device, the tracked target can provide multiple signal points, calculated using the antennas' phase center as the point of reference, to determine the device's physical position without using multiple RF transmit circuits or devices.

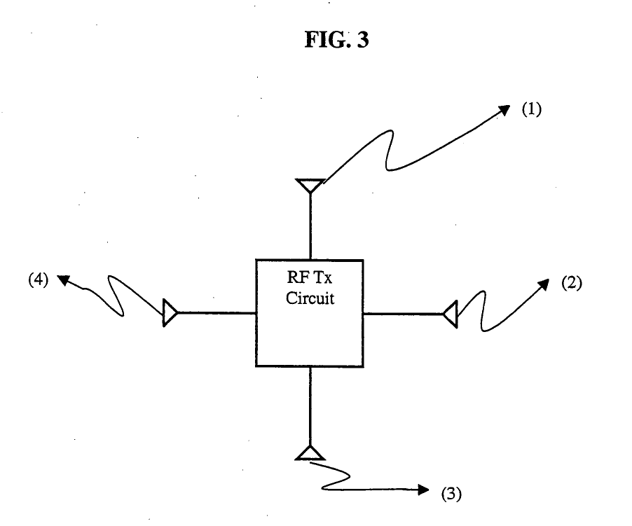

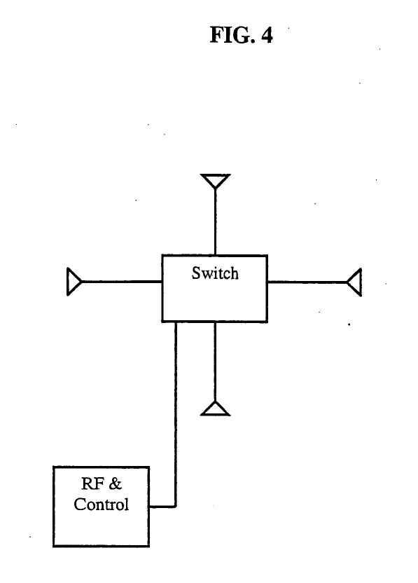

In the preferred embodiment, each device uses a single RF circuit with at least two antennas. In such a device there is a multiplexing sequence, performed in time (Time Division Multiplexing), activated at the RF circuit to each antenna (FIG. 3). This sequence is made possible through a switch as part of the RF circuit that activates the RF emissions at each antenna (FIG. 4). The RF circuit initiates the transmission function and the switch sequences this transmission at each antenna in a predetermined order (FIG. 4). This sequence as well as the antenna position on the device is known by the position tracking system and is used to gather multiple position reference points despite the use of a single RF circuit.

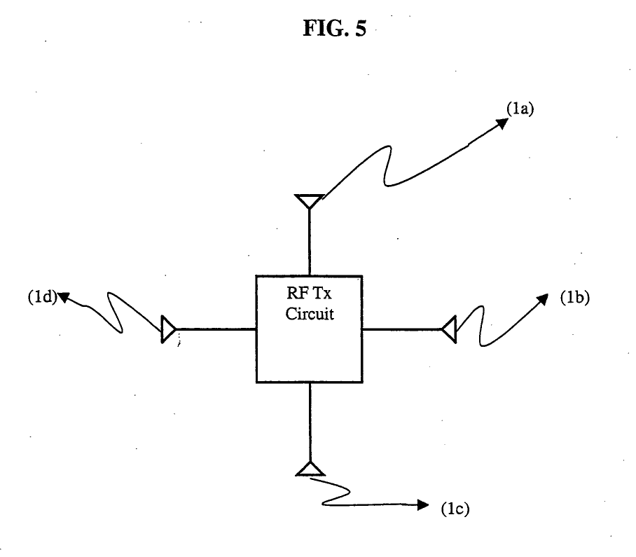

Other embodiments make use of different codes at each antenna to provide discernable transmission points despite the transmissions potentially being activated by the RF circuit at the same moment in time (FIG. 5). This use of code (Code Division Multiplexing as one example) can provide the same multiple position references on the device without a time-division multiplexing switch being utilized.

I claim:

1. A system for tracking an object, comprising:
a transmitter carried on or embedded within the object, each transmitter transmitting an electromagnetic signal using multiple, physically separated antennas on or within the object;
a plurality of receiver stations operative to receive the electromagnetic signal from the antennas; and
a processor operative to determine the position of the object in multiple dimensions based upon the time difference of arrival of the signal transmitted by each antenna.

2. The system of claim 1, wherein the phase center of the antennas is used as a point of reference to determine the position of the device without the need for multiple transmitters.

3. The system of claim 1, wherein the processor is operative to determine the position of the object in three dimensions.

4. The system of claim 1, wherein the processor is operative to determine the position of the object with up to six degrees of freedom.
